(19) United States
(12) Patent Application Publication
(10) Pub. No.: US 2021/0316592 A1
(43) Pub. Date: Oct. 14, 2021

(54) PIPING SYSTEM FOR AIR CONDITIONER

(71) Applicants: HYUNDAI MOTOR COMPANY, SEOUL (KR); KIA MOTORS CORPORATION, SEOUL (KR); HS R & A CO.,LTD., YANGSAN-SI (KR)

(72) Inventors: Jung Ha Park, Gunpo-si (KR); Deok Hyun Lim, Yangsan-si (KR); Young Jun Kim, Yangsan-si (KR)

(21) Appl. No.: 17/193,419

(22) Filed: Mar. 5, 2021

(30) Foreign Application Priority Data
Apr. 9, 2020 (KR) 10-2020-0043084

(51) Int. Cl. B60H 1/00; F16L 3/12; F16L 13/02

(52) U.S. Cl. CPC B60H 1/00571; B29C 65/1635; F16L 13/0209; F16L 3/1222

(57) ABSTRACT

Disclosed herein is a piping system for an air conditioner, in which a refrigerant pipe being an air conditioning piping of a vehicle and a flange member are each made of a plastic material, and the refrigerant pipe and the flange member can be connected by laser fusing. That is, the present disclosure provides the piping system for an air conditioner, in which the refrigerant pipe and the flange member are each made of a plastic material having a vibration insulation effect and are connected by laser fusing which can prevent damage so that an effect of weight reduction and vibration insulation can be provided and a pressure loss of a refrigerant fluid can be minimized by maintaining a diameter of the refrigerant pipe to be constant with respect to an overall length of the refrigerant pipe.

### CROSS REFERENCE TO RELATED APPLICATIONS

This application claims under 35 U.S.C. § 119(a) the benefit of priority to Korean Patent Application No. 10-2020-0043084 filed on Apr. 9, 2020, the entire contents of which are incorporated herein by reference.

### BACKGROUND

### (a) Technical Field

The present disclosure relates to a piping system for an air conditioner. More particularly, to a piping system for an air conditioner, in which a refrigerant pipe and a flange member, which are an air conditioning piping of a vehicle, are each made of a plastic material, and the refrigerant pipe and the flange member are connected by laser fusing so that the piping system is capable of providing an effect of weight reduction and vibration insulation and minimizing a pressure loss of a refrigerant fluid.

### (b) Background Art

Generally, a refrigeration cycle for operating a vehicle air conditioner is achieved by circulating a refrigerant through a compressor, a condenser, an expansion valve, and an evaporator.

To this end, the compressor, the condenser, the expansion valve, and the evaporator are sequentially connected by a refrigerant pipe and a flange member which constitute a piping system for an air conditioner to form one refrigerant circulation circuit.

The refrigerant pipe and the flange member which constitute a conventional piping system for an air conditioner are manufactured using a metal material such as aluminum and connected using a caulking method, a brazing method, and a soldering method.

For reference, the caulking method is referred to as a method of press-fitting the refrigerant pipe into an engagement hole of the flange member after forming end reduction or expansion of the refrigerant pipe.

The brazing method and the soldering method are referred to as a method of melting only a filler metal, such as lead, between base materials (between the refrigerant pipe and the flange member) to allow the base materials to be metal-bonded to each other.

However, the conventional piping system for an air conditioner has the following problems.

First, since the refrigerant pipe is made of an aluminum material, the refrigerant pipe is vulnerable to vibrations due to vehicle traveling and an engine so that a local portion of the refrigerant pipe is covered with a vibration insulation hose.

Thus, the piping system for an air conditioner requires a complicated structure and a higher production cost due to an increase in the number of parts used.

Second, owing to an impact when the refrigerant pipe and the flange member are connected through a caulking method or a brazing method, a diameter of an end portion of the refrigerant pipe (a portion engaged with the flange member) is deformed or a step difference occurs. Thus, the diameter of the refrigerant pipe becomes irregular along the entire length thereof, which causes a pressure loss of a refrigerant fluid flowing in the refrigerant pipe.

Third, when an impact of brazing fusing between the refrigerant pipe and the flange member is excessively transmitted to the refrigerant pipe or a temperature for brazing exceeds an appropriate temperature, quality defects such as unexpected damage or puncture of the refrigerant pipe may occur.

### SUMMARY

The present disclosure has been made in an effort to solve the above-described problems associated with prior art.

In one aspect, the present disclosure provides a piping system for an air conditioner, in which a refrigerant pipe and a flange member are each made of a plastic material having a vibration insulation effect and are connected by laser fusing which is capable of preventing damage so that the piping system is capable of providing an effect of weight reduction and vibration insulation and minimizing a pressure loss of a refrigerant fluid by maintaining a diameter of the refrigerant pipe to be constant with respect to an overall length of the refrigerant pipe.

Objectives of the present disclosure are not limited to the above-described objectives, and other objectives of the present disclosure, which are not mentioned, can be understood by the following description and also will be apparently understood through embodiments of the present disclosure. Further, the objectives of the present disclosure can be implemented by means described in the appended claims and a combination thereof.

In an exemplary embodiment, the present disclosure provides a piping system for an air conditioner, which includes a refrigerant pipe made of a plastic material and arranged along a predetermined air conditioning piping arrangement line, and a first flange member made of a plastic material and configured to interconnect the refrigerant pipe to parts constituting an air conditioning system, wherein bonding between the first flange member and the refrigerant pipe is made by laser fusing.

In another exemplary embodiment, the present disclosure provides a piping system for an air conditioner, which includes a refrigerant pipe made of a plastic material and arranged along a predetermined air conditioning piping arrangement line, and a second flange member made of a plastic material and configured to interconnect between the refrigerant pipes, wherein bonding between the second flange member and the refrigerant pipe is made by laser fusing.

In still another exemplary embodiment, the present disclosure provides a piping system for an air conditioner, which includes a refrigerant pipe made of a plastic material and arranged along a predetermined air conditioning piping arrangement line, a first flange member made of a plastic material and configured to interconnect the refrigerant pipe to parts constituting an air conditioning system, and a second flange member made of a plastic material and configured to interconnect between the refrigerant pipes, wherein bonding between the first flange member and the refrigerant pipe and bonding between the second flange member and the refrigerant pipe are made by laser fusing.

The refrigerant pipe may be made of a laser-absorbing plastic material, and each of the first flange member and the second flange member may be made of a laser-transmitting plastic material.

Thus, in a state in which one end portion of the refrigerant pipe is press-inserted into the first flange member and the second flange member, energy of a laser transmitted and emitted from the outside of the first flange member or the second flange member may be absorbed by the refrigerant pipe, and thus the bonding between the refrigerant pipe and the first flange member and the bonding between the refrigerant pipe and the second flange member may be made according to the laser fusing.

When a local portion of the refrigerant pipe needs to be bent at a predetermined angle so as to avoid interference with surrounding parts, a rubber hose may be applied to the local portion to connect between the refrigerant pipes.

The first flange member may include a hollow body, an inner pipe formed to extend from an outer diameter portion of the body in an axial direction of one side of the body, an outer pipe formed to extend from the outer diameter portion of the body in the axial direction of the one side of the inner pipe and arranged to be spaced apart from an outer diameter portion of the inner pipe, and a connection pipe formed to extend from the outer diameter portion of the body in an axial direction of the other side of the body to be engaged with parts of the air conditioning system, wherein a separation space between the inner pipe and the outer pipe is formed as a pipe engagement space into which the refrigerant pipe is press-inserted.

The second flange member may include a hollow body, inner pipes formed to extend from the outer diameter portion of the body in an axial direction of both sides of the body, and outer pipes formed to extend from the outer diameter portion of the body in the axial direction of the both sides of the body and arranged to be spaced apart from outer diameter portions of the inner pipes, wherein a separation space between the inner pipe and the outer pipe may be formed as a pipe engagement space into which the refrigerant pipe is press-inserted.

An inclined guide surface having an expanded pipe cross section for press-inserting guidance of the refrigerant pipe may be formed on an outer diameter portion of a distal end of the inner pipe and an inner diameter portion of a distal end of the outer pipe.

Thus, after the refrigerant pipe is press-inserted into a pipe engagement space between the inner pipe and the outer pipe, energy of a laser transmitted and emitted from the outside of the outer pipe may be absorbed into the refrigerant pipe so that the refrigerant pipe is laser fused into the pipe engagement space.

A chip storage groove may be further formed at an proximal end portion of the pipe engagement space to store chips which are generated during laser fusing.

In addition, a cradle end having a mounting hole for fixing a surrounding refrigerant pipe or fixing the flange member to a vehicle body may further be integrally formed to extend from the outer diameter portion of the body in a radial direction.

A hollow metal insert may be forcibly press-inserted into the mounting hole of the cradle end.

Other aspects and preferred embodiments of the present disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a schematic diagram illustrating an arrangement example of a piping system for an air conditioner according to the present disclosure;

FIGS. 2 and 3 are cross-sectional views illustrating states before and after bonding between a refrigerant pipe and a first flange member among components of the piping system for an air conditioner according to the present disclosure;

FIG. 4 is a schematic diagram illustrating an actual bonding state between the refrigerant pipe and the first flange member among the components of the piping system for an air conditioner according to the present disclosure;

FIGS. 5 and 6 are cross-sectional views illustrating states before and after bonding through a second flange member between the refrigerant pipes among the components of the piping system for an air conditioner according to the present disclosure; and

FIGS. 7A and 7B are schematic diagrams illustrating that a rubber hose is applicable to a local portion required for bending of the refrigerant pipe among the components of the piping system for an air conditioner according to the present disclosure.

It should be understood that the appended drawings are not necessarily to scale, presenting a somewhat simplified representation of various preferred features illustrative of the basic principles of the present disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, exemplary embodiments of the present disclosure will be described in detail with reference to the accompanying drawings.

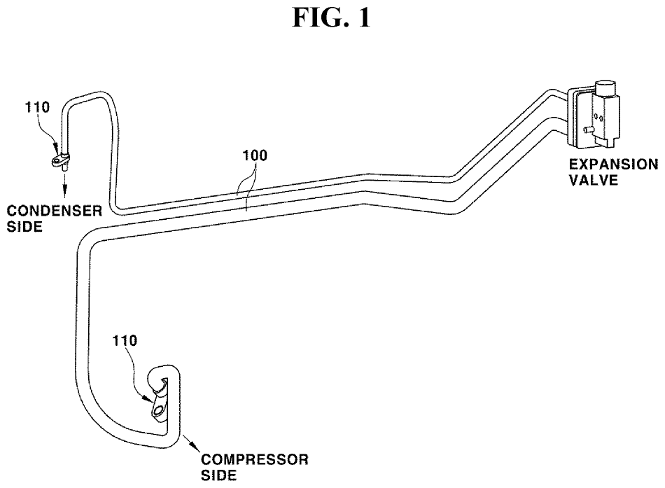

FIG. 1 is a schematic diagram illustrating an example in which a piping system for an air conditioner according to the present disclosure is arranged on a front side of a vehicle, and reference numeral 100 denotes a refrigerant pipe.

The refrigerant pipe 100 is a pipe made of a plastic material, is connected between a compressor and an expansion valve which are components constituting an air conditioning system of the vehicle, and is also connected between an expansion valve and a condenser.

In particular, the refrigerant pipe 100 is connected to the components (the compressor, the expansion valve, and the condenser) constituting the air conditioning system via a first flange member 110 made of a plastic material to allow a refrigerant to flow.

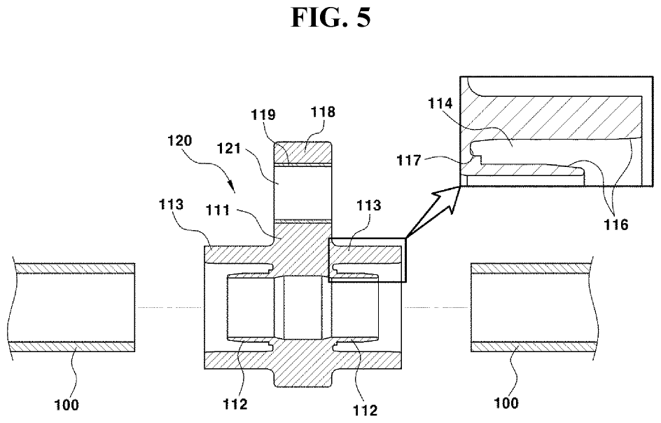

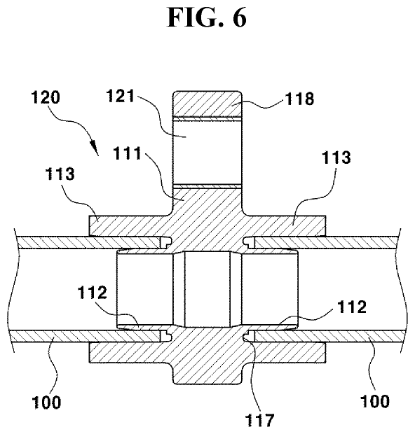

In addition, when an installation path of the refrigerant pipe 100 is long, two refrigerant pipes 100 may be provided, and thus one refrigerant pipe 100 and another refrigerant pipe 100 may be connected through a second flange member 120 (shown in FIGS. 5 and 6) made of a plastic material.

Thus, the compressor, the condenser, the expansion valve, and the evaporator, which are components constituting the air conditioning system, are sequentially connected by the refrigerant pipe 100 and the first and second flange members 110 and 120 which are each made of a plastic material to form one refrigerant circulation circuit.

As described above, the refrigerant pipe 100 and the first and second flange members 110 and 120 are each made of a plastic material so that it is possible to achieve an effect of weight reduction and self-insulation of vibrations due to vehicle traveling and an engine.

That is, the refrigerant pipe 100 and the first and second flange members 110 and 120 are each made of a plastic material so that the refrigerant pipe 100 and the first and second flange members 110 and 120 may have damping capability against vibrations generated from the engine and the like, and improved vibration resistance as compared with a conventional refrigerant pipe made of an aluminum material.

In addition, by excluding such a conventional configuration that a separate vibration insulation hose for vibrations due to vehicle traveling and an engine covers an aluminum pipe due to application of an aluminum material to a refrigerant pipe and a flange member, the number of parts and production cost are reduced.

Here, bonding between the first flange member 110 and the refrigerant pipe 100 in a state in which the refrigerant pipe 100 is press-inserted into the first flange member 110, and bonding between the second flange member 120 and the refrigerant pipe 100 in a state in which the refrigerant pipe 100 is press-inserted into the second flange member 120 are accomplished by laser fusing which uses heat due to laser energy to perform fusing.

In some embodiments, the refrigerant pipe 100 is made of a laser-absorbing plastic material, and the first flange member 110 and the second flange member 120 are each made of a laser-transmitting plastic material.

In the process of forming the refrigerant pipe 100 with the laser-absorbing plastic material, in order to facilitate a processing and extrusion molding of the refrigerant pipe 100, a filler (a chemical for improving processability or extrudability due to a polymer chain) is added to the plastic material. When an added amount of the filler is large, extrusion moldability is good but heat resistance is degraded, and thus a content of the filler is minimized to allow the extrusion molded refrigerant pipe to have heat resistance which absorbs and endures heat of laser energy. In addition, a carbon black pigment which is a laser absorbing pigment, or a dye material may be added.

In addition, in the process of forming the first flange member 110 and the second flange member 120 with a laser-transmitting plastic material, a carbon black pigment affecting a transmission amount of a laser is excluded from the plastic material for each flange member, and a dark blue pigment or a white blue pigment, which is a pigment or a coloring material allowing transmission of a laser, is added.

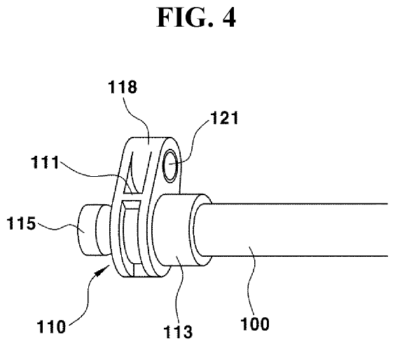

Referring to FIG. 4, since a laser-absorbing pigment or a laser-absorbing coloring material is used in the refrigerant pipe 100, the refrigerant pipe 100 has a black color which absorbs thermal energy of a laser beam, and it can be seen that, since a laser-transmitting pigment or a laser-transmitting coloring material is used in the first flange member 110, the first flange member 110 has a white-based color which transmits the laser beam.

Thus, in a state in which one end portion of the refrigerant pipe 100 is press-inserted into the first flange member 110 or the second flange member 120, energy of the laser beam incident from the outside of the first flange member 110 or the second flange member 120 is transmitted to each of the first and second flange members 110 and 120 to be absorbed into the refrigerant pipe 100 so that thermal bonding is achieved due to laser fusing between the refrigerant pipe 100 and the first flange member 110 or between the refrigerant pipe 100 and the second flange member 120.

In this case, when the energy of the laser beam passes through each of the first and second flange members 110 and 120 made of a laser-transmitting plastic material and then is absorbed by the refrigerant pipe 100 made of a laser-absorbing plastic material, the energy of the laser beam activates molecules in an absorption layer, and heat generated due to kinetic energy of the activated molecules fuses the first and second flange members 110 and 120 so that the refrigerant pipe 100 and the first and second flange members 110 and 120, which are two base materials, are thermally bonded.

As described above, the refrigerant pipe 100 and the first and second flange members 110 and 120, which are each made of a plastic material, are connected by laser fusing which uses heat due to energy of a laser so that the refrigerant pipe 100 and the first and second flange members 110 and 120 may be firmly bonded to each other without any damage (occurrence of deformation, a step difference, a puncture, or the like).

That is, in the related art, a quality defect such as deformation, a step difference, a puncture, or the like occurs in a connection portion between the refrigerant pipe and the flange member due to an impact when the refrigerant pipe and the flange member, which are made of an aluminum material, are connected by a caulking method or a brazing method. However, according to the present disclosure, the refrigerant pipe 100 and the first and second flange members 110 and 120, which are each made of a plastic material, are connected by laser fusing which uses heat due to energy of the laser so that the refrigerant pipe 100 and the first and second flange members 110 and 120 may be firmly bonded to each other without any damage and defect (occurrence of deformation, a step difference, a puncture, or the like).

In addition, since the refrigerant pipe 100 and each of the first and second flange members 110 and 120 are bonded to each other without any damage by the laser fusing, the diameter of the refrigerant pipe 100 is maintained to be constant with respect to an overall length of the refrigerant pipe 100 so that a pressure loss of a refrigerant fluid may be minimized.

Here, a detailed description of a specific structure and a connection relationship of the refrigerant pipe and the flange member among the components of the piping system for an air conditioner according to the present disclosure will be made as follows.

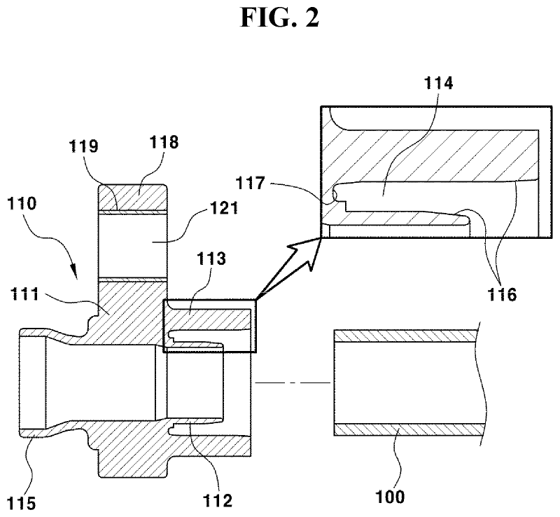

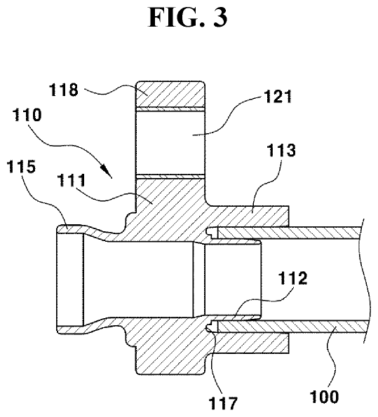

Referring to FIGS. 2 and 3, the first flange member 110 is for interconnecting between the refrigerant pipe 100 and parts constituting an air conditioning system and includes a body 111 having a hollow structure penetrated in a left-right direction, an inner pipe 112 formed to extend from one side portion of the body 111 in an axial direction, and an outer pipe 113 formed to extend from the one side portion of the body 111 in the axial direction and have a diameter that is greater than a diameter of the inner pipe 112.

In this case, since the outer pipe 113 has the diameter that is greater than the diameter of the inner pipe 112, the outer pipe 113 becomes a state of being arranged to be spaced apart from an outer diameter surface of the inner pipe 112, and a separation space between the inner pipe 112 and the outer pipe 113 is formed as a pipe engagement space 114 into which the refrigerant pipe 100 is press-inserted.

In addition, a connection pipe 115 is formed to extend from the other side portion of the body 111 in the axial direction. The connection pipe 115 becomes a portion connected to the components (the compressor, the condenser, and the like) of the air conditioning system.

Preferably, an inclined guide surface 116 having an expanding pipe cross section for press-fitting guidance of the refrigerant pipe 100 is formed on an outer diameter portion of a distal end of the inner pipe 112 and an inner diameter portion of a distal end of the outer pipe 113. Thus, the refrigerant pipe 100 may be easily press-inserted into the pipe engagement space 114 through the inclined guide surface 116.

In addition, a chip storage groove 117 is further formed at an inner distal end portion of the pipe engagement space 114 to store chips which are generated during laser fusing.

Thus, when the refrigerant pipe 100 is press-inserted into the pipe engagement space 114 between the inner pipe 112 and the outer pipe 113, and then a laser beam is incident from the outside of the outer pipe 113, energy of the laser beam passes through the first flange member 110 made of a laser-transmitting plastic material and is absorbed into the refrigerant pipe 100 made of a laser-absorbing plastic material to activate molecules in the absorption layer, and thus heat generated due to kinetic energy of the activated molecules fuses the first flange member 110. Consequently, the refrigerant pipe 100 is thermally bonded to the first flange member 110 in the pipe engagement space 114.

In this case, during the laser fusing, chips may be generated due to separation from the refrigerant pipe 100 or the first and second flange members 110 and 120. However, the chips are stored in the chip storage groove 117 formed at the inner distal end portion of the pipe engagement space 114 to be not leaked to the outside so that it is possible to prevent a phenomenon in which the chips are mixed with the refrigerant even later.

Referring to FIGS. 5 and 6, the second flange member 120 is for interconnecting between two refrigerant pipes 100 and includes a body 111 having a hollow structure penetrated in a left-right direction, inner pipes 112 each formed to extend from two side portions of the body 111 in the axial direction, and outer pipes 113 each formed to extend from the two side portions of the body 111 in the axial direction and have a diameter that is greater than a diameter of each inner pipe 112.

Similarly, since the outer pipe 113 has the diameter that is greater than the diameter of the inner pipe 112, the outer pipe 113 becomes a state of being arranged to be spaced apart from an outer diameter surface of the inner pipe 112, and a separation space between the inner pipe 112 and the outer pipe 113 is formed as a pipe engagement space 114 into which the refrigerant pipe 100 is press-inserted.

In addition, an inclined guide surface 116 having an expanding pipe cross section for press-fitting guidance of the refrigerant pipe 100 is formed on an outer diameter portion of a distal end of the inner pipe 112 and an inner diameter portion of a distal end of the outer pipe 113, wherein the inner pipe 112 and the outer pipe 113 constitute the second flange member 120. Thus, the two refrigerant pipes 100 may be easily press-inserted into each pipe engagement space 114 through the inclined guide surface 116.

In addition, a chip storage groove 117 is further formed at an inner distal end portion of the pipe engagement space 114 to store chips which are generated during laser fusing.

Thus, when the two refrigerant pipes 100 are press-inserted into the pipe engagement spaces 114 formed at both sides of the second flange member 120, and then a laser beam is incident from the outside of the outer pipe 113, energy of the laser beam passes through the second flange member 120 made of a laser-transmitting plastic material and is absorbed into the two refrigerant pipes 100 each made of a laser-absorbing plastic material to activate molecules in the absorption layer, and thus heat generated due to kinetic energy of the activated molecules fuses the second flange member 120. Consequently, the two refrigerant pipes 100 are thermally bonded to the second flange member 120 in the pipe engagement spaces 114, and the two refrigerant pipes 100 become a state of being easily connected by the second flange member 120.

Similarly, during the laser fusing, chips may be generated due to separation from the refrigerant pipe 100 or the first and second flange members 110 and 120. However, the chips are stored in the chip storage groove 117 formed at the inner distal end portion of each pipe engagement space 114 to be not leaked to the outside so that it is possible to prevent a phenomenon in which the chips are mixed with the refrigerant even later.

Meanwhile, a cradle end 118 having a mounting hole 119 is integrally formed to further extend at a predetermined position on an outer diameter surface of the body 111 of the first and second flange members 110 and 120.

Thus, when the first and second flange members 110 and 120 are fixed at predetermined positions on a vehicle body, a bolt is inserted into the vehicle body through the mounting hole 119 of the cradle end 118 to perform bolting on the vehicle body so that the first and second flange members 110 and 120 may be firmly fixed to the vehicle body while supporting the refrigerant pipe 100.

In addition, the mounting hole 119 of the cradle end 118 may be used for the purpose of inserting and fixing a refrigerant pipe disposed in the periphery of the mounting hole 119 thereof.

Preferably, a hollow metal insert 121 is forcibly press-inserted into the mounting hole 119 of the cradle end 118.

When the hollow metal insert 121 is omitted from the mounting hole 119 of the cradle end 118, owing to an engagement torque of the bolt which is engaged into the mounting hole 119, damage or cracks may occur around the mounting hole 119. However, since the hollow metal insert 121 is forcibly press-inserted into the mounting hole 119 of the cradle end 118, it is possible to prevent occurrence of damage and cracks due to the engagement torque of the bolt.

Meanwhile, the refrigerant pipe 100 is disposed and installed to form a predetermined arrangement as being connected between the compressor and the expansion valve which are components constituting the air conditioning system of the vehicle and also being connected between the expansion valve and the condenser. When specific parts of the vehicle are present on a path where the refrigerant pipe 100 is disposed and installed, a local portion of the refrigerant pipe 100 should be bent.

Alternatively, the refrigerant pipe 100 may be manufactured by extrusion molding a plastic material and then bending the extrusion molded plastic material using predetermined bending equipment. However, thereafter in order to avoid interference with surrounding parts, there may occur a case in which the local portion of the refrigerant pipe 100 should further be bent at a predetermined angle.

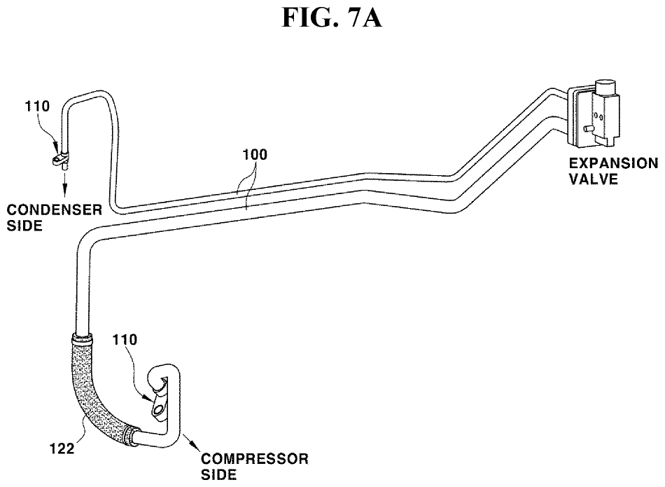

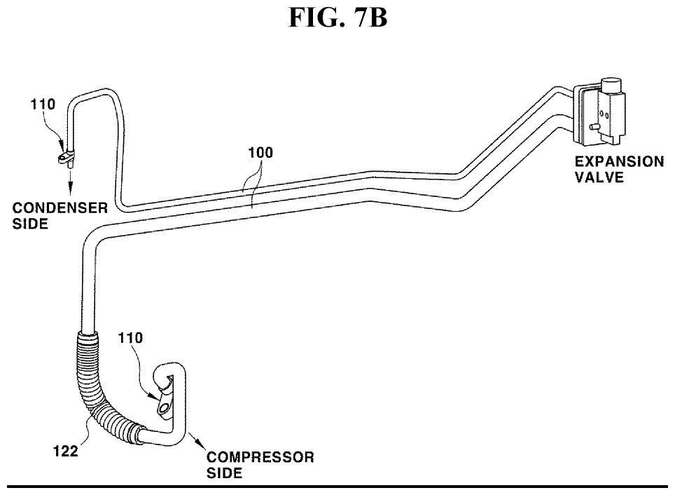

Thus, as shown in FIGS. 7A and 7B, a rubber hose 122 connecting between the refrigerant pipes 100 may be applied to a local portion in which the refrigerant pipe 100 is required to be bent.

That is, when the local portion of the refrigerant pipe 100 should be bent at a predetermined angle so as to avoid interference with the surrounding parts, the rubber hose 122 in the form of a straight pipe or a bellows corrugated pipe having vibration insulation may be connected between the refrigerant pipes corresponding to the local portion by laser fusing.

As described above, the refrigerant pipe 100 and the first and second flange members 110 and 120, which constitute the piping system for an air conditioner of a vehicle, are each made of a plastic material having a vibration insulation effect and are connected by laser fusing which is capable of preventing damage so that an effect of weight reduction and vibration insulation may be provided and a diameter of the refrigerant pipe 100 may be maintained to be constant with respect to an overall length of the refrigerant pipe 100, thereby minimizing a pressure loss of a refrigerant fluid.

The present disclosure provides the following effects through the above-described problem solving means.

First, a refrigerant pipe and a flange member are each made of a plastic material so that it is possible to achieve an effect of weight reduction and self-insulation of vibrations due to vehicle traveling and an engine.

Second, the refrigerant pipe and the flange member, which are each made of a plastic material, are mutually connected by laser fusing which uses heat due to energy of a laser so that the refrigerant pipe and the flange member can be firmly bonded to each other without any damage (occurrence of deformation, a step difference, a puncture, or the like).

Third, since the refrigerant pipe and the flange member are bonded to each other without any damage by the laser fusing, a diameter of the refrigerant pipe is maintained to be constant with respect to an overall length of the refrigerant pipe so that a pressure loss of a refrigerant fluid can be minimized.

The effects of the present disclosure are not limited to the above-described effects. It should be understood that the effects of the present disclosure include all effects which can be inferred from the above description.

While the embodiments of the present disclosure have been described with reference to the accompanying drawings, those skilled in the art can understand that the present disclosure can be implemented in other specific forms without departing from the technical spirit or the necessary features of the present disclosure. Therefore, it should be understood that the above-described embodiments are not restrictive but illustrative in all aspects.

1. A piping system for an air conditioner, comprising:
a refrigerant pipe made of a plastic material and arranged along a predetermined air conditioning piping arrangement line;
a first flange member made of a plastic material and configured to interconnect the refrigerant pipe to parts constituting an air conditioning system;
wherein the first flange member is laser fused to the refrigerant pipe.

2. The piping system for an air conditioner of claim 1, wherein the refrigerant pipe is made of a laser-absorbing plastic material, and the first flange member is made of a laser-transmitting plastic material so that, in a state in which one end portion of the refrigerant pipe is press-inserted into the first flange member, energy of a laser transmitted and emitted from the outside of the first flange member is absorbed by the refrigerant pipe.

3. The piping system for an air conditioner of claim 1, wherein, when a local portion of the refrigerant pipe is bent at a predetermined angle so as to avoid interference with surrounding parts, a rubber hose in a form of a straight pipe or a corrugated bellows pipe is applied to the local portion to connect the refrigerant pipes.

4. The piping system for an air conditioner of claim 1, wherein the first flange member includes:
a hollow body;
an inner pipe extending from one side portion of the hollow body in an axial direction;
an outer pipe extending from the one side portion of the hollow body in the axial direction and having a diameter that is greater than a diameter of the inner pipe;
a connection pipe extending from the other side portion of the hollow body in the axial direction to be engaged with parts of the air conditioning system; and
a cradle end provided in a structure having a mounting hole to fix the first flange member to a vehicle body, wherein the cradle end is integrally formed on an outer diameter portion of the hollow body;
wherein a separation space between the inner pipe and the outer pipe is formed as a pipe engagement space into which the refrigerant pipe is press-inserted, and, after the refrigerant pipe is press-inserted into the pipe engagement space, energy of a laser transmitted and emitted from the outside of the outer pipe is absorbed into the refrigerant pipe so that the refrigerant pipe is laser-fused into the pipe engagement space.

5. The piping system for an air conditioner of claim 4, wherein an inclined guide surface having an expanded pipe cross section for press-inserting guidance of the refrigerant pipe is formed on an outer diameter portion of a distal end of the inner pipe and an inner diameter portion of a distal end of the outer pipe.

6. The piping system for an air conditioner of claim 4, wherein a chip storage groove is further formed at an inner proximal end portion of the pipe engagement space to store chips which are generated during laser fusing.

7. The piping system for an air conditioner of claim 4, wherein a hollow metal insert is forcibly press-inserted into the mounting hole of the cradle end.

8. A piping system for an air conditioner, comprising:
a refrigerant pipe made of a plastic material and arranged along a predetermined air conditioning piping arrangement line; and
a second flange member made of a plastic material and configured to interconnect between the refrigerant pipes;
wherein the second flange member is laser fused to the refrigerant pipe.

9. The piping system for an air conditioner of claim 8, wherein the refrigerant pipe is made of a laser-absorbing plastic material, and the second flange member is made of a laser-transmitting plastic material so that, in a state in which one end portion of the refrigerant pipe is press-inserted into the second flange member, energy of a laser transmitted and emitted from the outside of the second flange member is absorbed by the refrigerant pipe.

10. The piping system for an air conditioner of claim 8, wherein when a local portion of the refrigerant pipe is bent at a predetermined angle so as to avoid interference with surrounding parts, a rubber hose in a form of a straight pipe or a corrugated bellows pipe is applied to the local portion to connect the refrigerant pipes.

11. The piping system for an air conditioner of claim 8, wherein the second flange member includes:
a hollow body;
inner pipes extending from two side portions of the hollow body in an axial direction;
outer pipes extending from the two side portions of the hollow body in the axial direction and arranged to be spaced apart from outer diameter portions of the inner pipes;
the outer pipes extending from two side portions of the hollow body in the axial direction and each formed to have a diameter that is greater than a diameter of the inner pipe; and
a cradle end provided in a structure having a mounting hole to fix the second flange member to a vehicle body, wherein the cradle end is integrally formed on an outer diameter portion of the hollow body;
wherein a separation space between the inner pipe and the outer pipe is formed as a pipe engagement space into which the refrigerant pipe is press-inserted, and, after the refrigerant pipe is press-inserted into the pipe engagement space between the inner pipe and the outer pipe, energy of a laser transmitted and emitted from the outside of the outer pipe is absorbed into the refrigerant pipe so that the refrigerant pipe is laser-fused into the pipe engagement space.

12. The piping system for an air conditioner of claim 11, wherein an inclined guide surface having an expanded pipe cross section for press-inserting guidance of the refrigerant pipe is formed on an outer diameter portion of a distal end of the inner pipe and an inner diameter portion of a distal end of the outer pipe.

13. The piping system for an air conditioner of claim 11, wherein a chip storage groove is further formed at an inner proximal end portion of the pipe engagement space to store chips which are generated during laser fusing.

14. The piping system for an air conditioner of claim 11, wherein a hollow metal insert is forcibly press-inserted into the mounting hole of the cradle end.

15. A piping system for an air conditioner, comprising:
a refrigerant pipe made of a plastic material and arranged along a predetermined air conditioning piping arrangement line;
a first flange member made of a plastic material and configured to interconnect the refrigerant pipe to parts constituting an air conditioning system; and
a second flange member made of a plastic material and configured to interconnect the refrigerant pipes;
wherein the first flange member is laser fused to the refrigerant pipe, and the second flange member is laser fused to the refrigerant pipe.

16. The piping system for an air conditioner of claim 1, wherein the refrigerant pipe is made of a laser-absorbing plastic material, and each of the first flange member and the second flange member is made of a laser-transmitting plastic material so that, in a state in which one end portion of the refrigerant pipe is press-inserted into the first flange member and the second flange member, energy of a laser transmitted and emitted from the outside of the first flange member and the second flange member is absorbed by the refrigerant pipe.

17. The piping system for an air conditioner of claim 1, wherein, when a local portion of the refrigerant pipe is bent at a predetermined angle so as to avoid interference with surrounding parts, a rubber hose in a form of a straight pipe or a corrugated bellows pipe is applied to the local portion to connect the refrigerant pipes.

18. The piping system for an air conditioner of claim 1, wherein the first flange member includes:
a hollow body;
an inner pipe extending from one side portion of the body in an axial direction;
an outer pipe extending from the one side portion of the body in the axial direction and have a diameter that is greater than a diameter of the inner pipe;
a connection pipe extending from the other side portion of the body in the axial direction to be engaged with parts of the air conditioning system; and
a cradle end provided in a structure having a mounting hole to fix the first flange member to a vehicle body, wherein the cradle end is integrally formed on an outer diameter portion of the body;
the second flange member includes:
a second hollow body;
second inner pipes extending from two side portions of the second hollow body in an axial direction;
second outer pipes extending from the two side portions of the second hollow body in the axial direction and arranged to be spaced apart from outer diameter portions of the second inner pipes;
the second outer pipes extending from two side portions of the second hollow body in the axial direction and each formed to have a diameter that is greater than a diameter of the inner pipe; and
a second cradle end provided in a structure having a mounting hole to fix the second flange member to a vehicle body, wherein the second cradle end is integrally formed on an outer diameter portion of the second hollow body;
wherein a separation space between the inner pipe and the outer pipe is formed as a pipe engagement space into which the refrigerant pipe is press-inserted, and, after the refrigerant pipe is press-inserted into the pipe engagement space between the inner pipe and the outer pipe, energy of a laser transmitted and emitted from the outside of the outer pipe is absorbed into the refrigerant pipe so that the refrigerant pipe is laser-fused into the pipe engagement space.

19. The piping system for an air conditioner of claim 18, wherein an inclined guide surface having an expanded pipe cross section for press-inserting guidance of the refrigerant pipe is formed on an outer diameter portion of a distal end of the inner pipe and an inner diameter portion of a distal end of the outer pipe.

20. The piping system for an air conditioner of claim 18, wherein a chip storage groove is further formed at an inner proximal end portion of the pipe engagement space to store chips which are generated during laser fusing.
